(19) United States
(12) Patent Application Publication
(10) Pub. No.: US 2023/0136079 A1
(43) Pub. Date: May 4, 2023

(54) CONTROL DEVICE, CONTROL METHOD, AND CONTROL PROGRAM PRODUCT

(71) Applicant: DENSO CORPORATION, Kariya-city, Aichi-pref. (JP)

(72) Inventors: Koudai YAMAURA, Kariya-city (JP); Masatake WADA, Kariya-city (JP); Takamasa Hidaka, Kariya-city (JP)

(21) Appl. No.: 18/147,504

(22) Filed: Dec. 28, 2022

Related U.S. Application Data
(63) Continuation of application No. PCT/JP21/21208, filed on Jun. 3, 2021.

(30) Foreign Application Priority Data
Jul. 13, 2020 (JP) 2020-119966

(51) Int. Cl. G08G 1/14; B60W 30/06

(52) U.S. Cl. CPC G08G 1/148; B60W 30/06; G08G 1/146

(57) ABSTRACT

A control device is configured to: set multiple time related areas in a parking space of an automated valet parking lot, the multiple time related areas being correlated to respective scheduled exit times different from one another; acquire a scheduled exit time of a vehicle to be parked in the automated valet parking lot; select, from the multiple time related areas, a target parking area of the vehicle corresponding to the acquired scheduled exit time; set a parking position of the vehicle in the selected target parking area. Each time related area is set to have a shorter travel distance to an exit room of the parking lot than other time related areas when the correlated scheduled exit time is earlier than those of other time related areas.

### CROSS REFERENCE TO RELATED APPLICATION

The present application is a continuation application of International Patent Application No. PCT/JP2021/021208 filed on Jun. 3, 2021, which designated the U.S. and claims the benefit of priority from Japanese Patent Application No. 2020-119966 filed on Jul. 13, 2020. The entire disclosures of all of the above applications are incorporated herein by reference.

### TECHNICAL FIELD

The present disclosure relates to a control device, a control method, and a control program product.

### BACKGROUND

Conventionally, a parking lot control device is well known. The parking lot control device determines a travel path to a parking space within the parking lot. The parking lot control device guides a vehicle to a parking space using an autonomous driving function of the vehicle. A parked vehicle is moved to an exit position when the vehicle prepares to exit from the parking lot.

### SUMMARY

The present disclosure provides a control device used in an automated valet parking lot. The control device is configured to: set multiple time related areas in a parking space of the automated valet parking lot, the multiple time related areas being correlated to respective scheduled exit times different from one another; acquire a scheduled exit time of a vehicle to be parked in the automated valet parking lot; select, from the multiple time related areas, a target parking area of the vehicle corresponding to the acquired scheduled exit time; set a parking position of the vehicle in the selected target parking area. Each time related area is set to have a shorter travel distance to an exit room of the parking lot than other time related areas when the correlated scheduled exit time is earlier than those of other time related areas.

### BRIEF DESCRIPTION OF DRAWINGS

Objects, features and advantages of the present disclosure will become apparent from the following detailed description made with reference to the accompanying drawings. In the drawings:

FIG. 1 is a diagram showing a schematic configuration of an automated valet parking lot;

FIG. 2 is a block diagram showing a configuration of a control system;

FIG. 3 is a block diagram showing a functional configuration of a control unit;

FIG. 4 is a sequence diagram showing an entrance process executed by the control system and a vehicle;

FIG. 5 is a sequence diagram showing an entrance process executed by the control system and the vehicle;

FIG. 6 is a sequence diagram showing an entrance process executed by the control system and the vehicle;

FIG. 7 is a sequence diagram showing an entrance process executed by the control system and the vehicle;

FIG. 8 is a sequence diagram showing an exit process executed by the control system and the vehicle;

FIG. 9 is a sequence diagram showing an exit process executed by the control system and the vehicle;

FIG. 10 is a flowchart showing a process which sets areas in a parking space;

FIG. 11 is a flowchart showing a moving process of a parked vehicle;

FIG. 12 is a diagram showing an example of moving of parked vehicle;

FIG. 13 is a diagram showing scheduled exit time set for each parking area; and

FIG. 14 is a flowchart showing a process which sets a target parking position.

### DETAILED DESCRIPTION

Inventors of the present disclosure found out the following issues. A parking lot management device may guide a vehicle to a parking position distant from an exit position within a parking lot even though the vehicle has an earlier scheduled exit time. In this case, a required time for the vehicle to move from the parking position to the exit position may be long, and the vehicle may fail to exit from the parking lot by the scheduled exit time.

According to the present disclosure, a control device, a control method, and a control program product are provided.

According to an aspect of the present disclosure, a control device, which is used in an automated valet parking lot, is provided. The automated valet parking lot includes an entrance room, an exit room, and a parking space.

The control device includes: an area setting unit setting a plurality of time related areas in the parking space, the plurality of time related areas being correlated to respective scheduled exit times different from one another; a time acquisition unit acquiring a scheduled exit time of a vehicle to be parked in the automated valet parking lot; an area selection unit selecting, from the plurality of time related areas, a target parking area of the vehicle corresponding to the scheduled exit time acquired by the time acquisition unit; and a parking position setting unit setting a parking position in the target parking area, which is selected by the area selection unit.

The area setting unit sets each of the plurality of time related areas to have a shorter travel distance to the exit room than other time related areas when the correlated scheduled exit time is earlier than those of other time related areas.

With the above control device, the vehicle having early scheduled exit time can be parked in the time related area, which has short travel distance to the exit room. As a result, the control device can control the vehicle having early scheduled exit time to exit from the automated valet parking lot within a short period of time, that is, by the scheduled exit time.

According to another aspect of the present disclosure, a control method, which is used in an automated valet parking lot, is provided. The automated valet parking lot includes an entrance room, an exit room, and a parking space.

The control method includes: setting a plurality of time related areas in the parking space, the plurality of time related areas being correlated to respective scheduled exit times different from one another; acquiring a scheduled exit time of a vehicle to be parked in the automated valet parking lot; selecting, from the plurality of time related areas, a target parking area of the vehicle corresponding to the acquired scheduled exit time; setting a parking position of the vehicle in the selected target parking area; and setting each of the plurality of time related areas to have a shorter travel distance to the exit room than other time related areas when the correlated scheduled exit time is earlier than those of other time related areas.

With the above control method, the vehicle having early scheduled exit time can be parked in the time related area, which has short travel distance to the exit room. As a result, the control method can control the vehicle having early scheduled exit time to exit from the automated valet parking lot within a short period of time, that is, by the scheduled exit time.

The following will describe embodiments of the present disclosure with reference to the accompanying drawings.

### First Embodiment

### 1. Configuration of Automated Valet Parking Lot

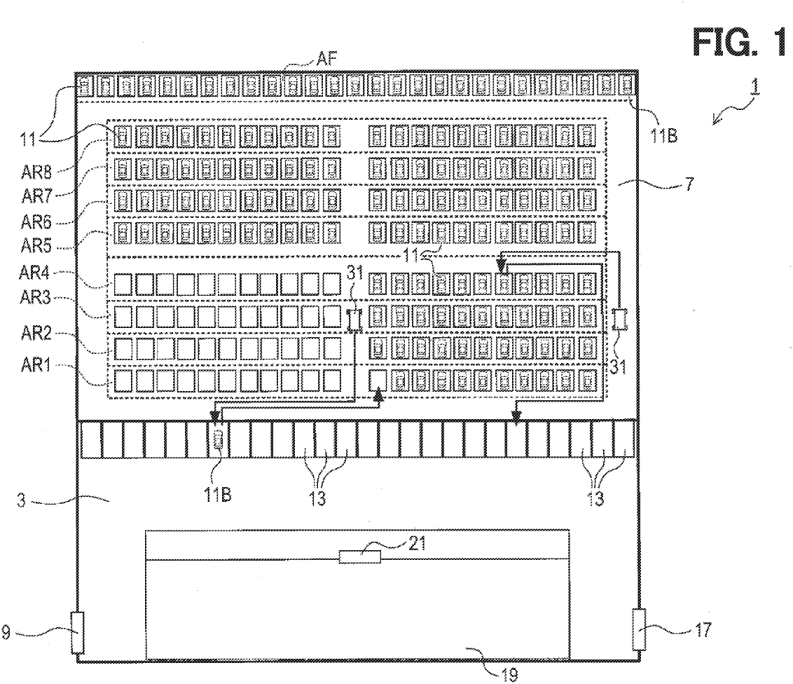

The following will describe a configuration of an automated valet parking lot 1 with reference to FIG. 1. The automated valet parking lot 1 includes an entrance and exit space 3 and a parking space 7.

The entrance and exit space 3 is adjacent to the parking space 7. The entrance and exit space 3 includes an entrance 9. A vehicle 11 to be parked from the outside of the automated valet parking lot 1 passes through the entrance 9, and enters the entrance and exit space 3. The vehicle 11 may be a vehicle 11A with an AVP function, or may be a vehicle 11B without the AVP function. The AVP function is an automated valet parking function.

The entrance and exit space 3 includes multiple entrance and exit rooms 13. Each entrance and exit room 13 corresponds to an entrance room, and also corresponds to an exit room. The multiple entrance and exit rooms 13 are aligned within the entrance and exit space 3 adjacent to the parking space 7. Each entrance and exit room 13 has a size capable of accommodating one vehicle 11. After the vehicle 11 entered the entrance and exit space 3 through the entrance 9, the vehicle 11 can stop at any one of the entrance and exit room 13. The vehicle 11 stopped in the entrance and exit room 13 may enter the parking space 7 by being transported by a parking robot 31, which will be described later, or by using the AVP function of the vehicle.

The entrance and exit room 13 may be fixed as the entrance room or exit room. Alternatively, a control system 23, which will be described later, may set the entrance and exit room 13 as the entrance room or as the exit room. For example, the control system 23 may change the setting of the entrance and exit room 13 from the entrance room to the exit room or from the exit room to the entrance room according to the time slot and a usage state of the automated valet parking lot 1.

After the vehicle 11 exits from the parking space 7, the vehicle 11 enters one vehicle entrance and exit room 13. The entrance and exit space 3 has an exit 17. The vehicle 11 in the entrance and exit room 13 passes through the exit 17, and then proceeds to the outside of the automated valet parking lot 1. The parking space 7 is a space in which multiple vehicles 11 can be parked.

The entrance and exit space 3 is adjacent to a facility 19. The facility 19 is, for example, a store, an office, a house, or a station. A doorway 21 of the facility 19 and the entrance and exit space 3 are connected via, for example, a pedestrian-only area.

### 2. Configuration of Control System 23

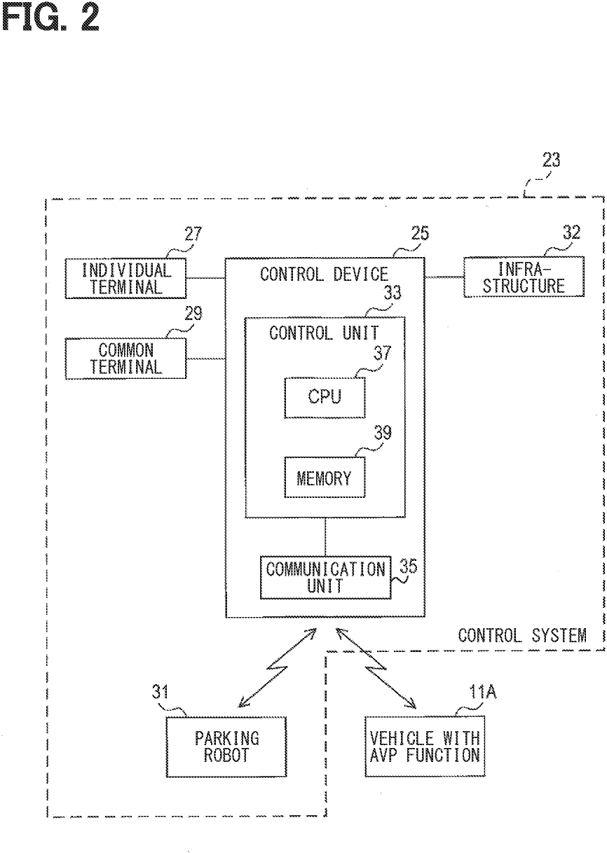

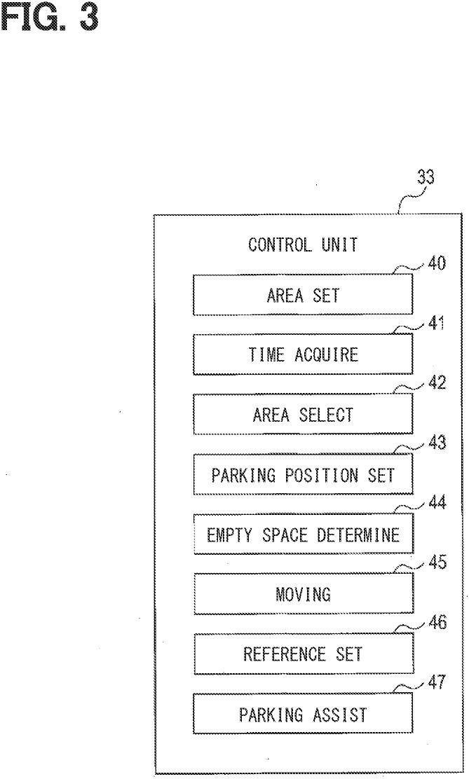

The following will describe a configuration of the control system 23 with reference to FIG. 2 and FIG. 3. The control system 23 is used for controlling the automated valet parking lot 1. As shown in FIG. 2, the control system 23 includes a control device 25, multiple individual terminals 27, a common terminal 29, a parking robot 31, and an infrastructure 32.

The control device 25 includes a control unit 33 and a communication unit 35. The control unit 33 includes a microcomputer. The microcomputer may include a CPU 37 and a semiconductor memory (hereinafter, referred to as a memory) 39, such as a RAM or a ROM.

Each function of the control unit 33 is implemented when a program, which is stored in a non-transitory tangible storage medium, is executed by the CPU 37. In this example, the memory 39 corresponds to the non-transitory tangible storage medium in which the program is stored. By executing the program, a method corresponding to the program is executed. The control unit 33 may include one microcomputer or multiple microcomputers.

As shown in FIG. 3, the control unit 33 includes, as functional blocks, an area setting unit 40, a time acquisition unit 41, an area selection unit 42, a parking position setting unit 43, an empty space determination unit 44, a moving unit 45, a reference setting unit 46, and a parking assist unit 47. The functions provided by the control unit 33 will be described later.

Each individual terminal 27 is correlated with one entrance and exit room 13. Each individual terminal 27 is positioned close to the corresponding entrance and exit room 13. The individual terminal 27 accepts the user’s operation. Examples of the user’s operation may include an entrance request operation and user identification information input. The individual terminal 27 displays information to the user.

The common terminal 29 is positioned in the entrance and exit space 3. The common terminal 29 accepts user’s operations. Examples of the user’s operation may include an exit request operation and user identification information input. The common terminal 29 includes a display unit. The display unit displays information to the user.

The parking robot 31 has the following functions. The parking robot 31 can perform wireless communication with the control device 25. The parking robot 31 can receive a travel path from the control device 25. The parking robot 31 has map information of the automated valet parking lot 1.

The parking robot 31 has a function of estimating an own position. The parking robot 31 can create position information representing the estimated own position. The parking robot 31 can travel along the travel path by using the map information, the position information, and the travel path.

The parking robot 31 can lift up the vehicle 11. The parking robot 31 can travel along the travel path with the vehicle 11 in lift-up state. The traveling of parking robot 31 with the vehicle 11 in lift-up state corresponds to that the parking robot 31 transports the vehicle 11. The parking robot 31 can also lowers the lifted vehicle 11 to the road surface. Hereinafter, the lowering of lifted vehicle 11 by the parking robot is also referred to as lift down.

The parking robot 31 can transmit the position information to the control device 25. The parking robot 31 can receive an instruction from the control device 25, and perform an operation corresponding to the instruction. For example, instructions include a stop, a start, and a reroute.

The infrastructure 32 includes multiple sensors for detecting states in respective parts of the automated valet parking lot 1. Examples of the sensors include cameras and LIDARs. Some of the cameras capture images of a license plate of the vehicle 11 in the entrance and exit room 13.

### 3. Entrance and Exit Related Process Executed by Control System 23 and Vehicle 11

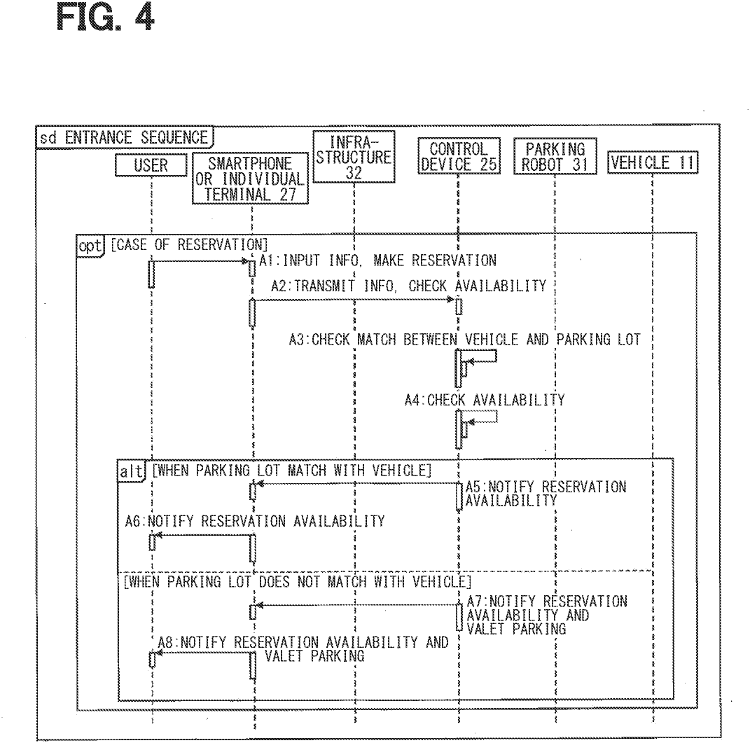

The following will describe an entrance and exit related process executed by the control system 23 and the vehicle 11 with reference to FIG. 4 to FIG. 7.

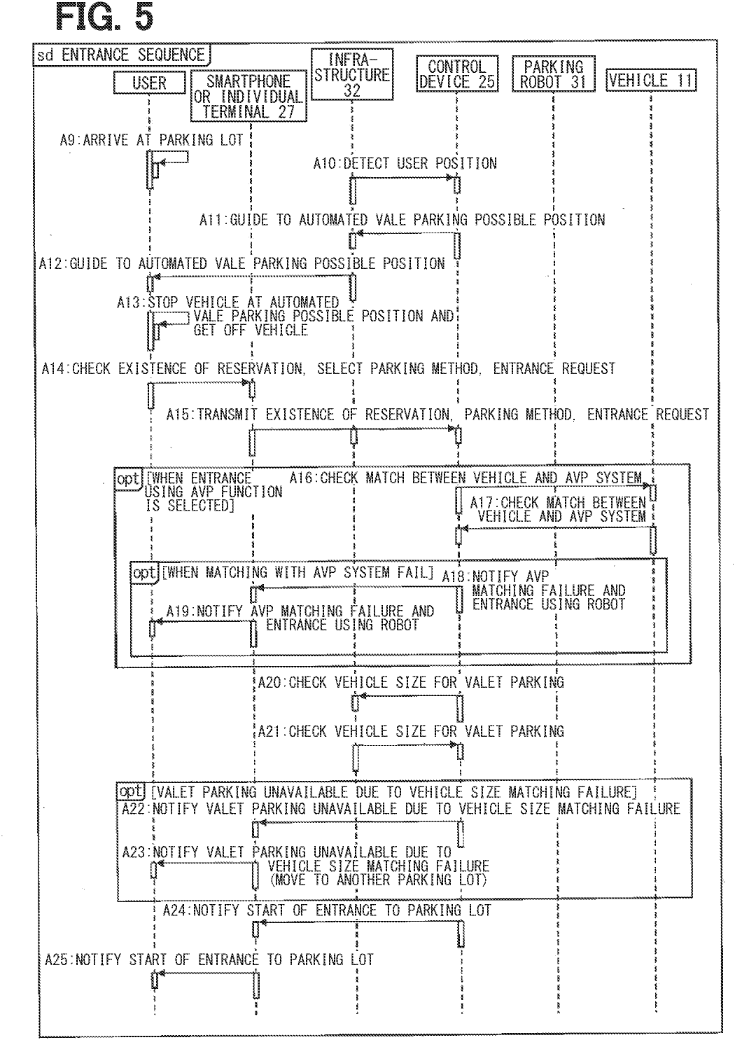

When a user makes an entrance reservation, the process executes A1 to A8 shown in FIG. 4. When a user does not make an entrance reservation, the process does not execute A1 to A8 shown in FIG. 4. In this case, the process proceeds to A9 shown in FIG. 5, and executes A9 and the following steps.

In A1, the user inputs information into a smartphone and performs an operation for entrance reservation. The smartphone is a terminal carried by the user. The information may include, for example, identification information of the vehicle 11, identification information of the user, scheduled entrance time, exit reservation, and a type of AVP system equipped to the vehicle 11. The information about exit reservation includes a scheduled exit time. The scheduled exit time is a scheduled time when the vehicle 11 parked in the parking space 7 is scheduled to exit from the parking lot.

In A2, the smartphone transmits the information input in A1 to the control device 25, and inquires whether the reservation is available.

In A3, the control device 25 checks matching between the automated valet parking lot 1 and the vehicle 11 based on the information received in A2. The matching between the automated valet parking lot 1 and the vehicle 11 indicates that the AVP system included in the vehicle 11 matches with the control system 23, and the AVP function of the vehicle 11 can be used.

In A4, the control device 25 acquires an availability of the parking space 7, and checks whether an entrance reservation is acceptable based on the acquired availability of parking space and matching result between the parking lot and the vehicle.

The process executes A5 and A6 only when the control device 25 determines that the automated valet parking lot 1 matches with the vehicle 11 in A3. In A5, the control device 25 notifies the smartphone whether the entrance reservation is available.

In A6, the smartphone notifies the user whether the entrance reservation is available.

The process executes A7 and A8 only when the control device 25 determines that the automated valet parking lot 1 does not match with the vehicle 11 in A3. In A7, the control device 25 notifies the smartphone whether the entrance reservation is available. The control device 25 notifies the smartphone that robot parking will be performed to the vehicle. The robot parking indicates the automated valet parking using the parking robot 31.

In A8, the smartphone notifies the user whether the reservation is available. The smartphone also notifies the user that the parking method is robot parking.

In A9, the user enters the automated valet parking lot 1. At this time, the user is onboard.

In A10, the infrastructure 32 detects positions of the user and the vehicle 11. The infrastructure 32 notifies, to the control device 25, the positions of the user and the vehicle 11.

In A11, the control device 25 instructs the infrastructure 32 to guide the user and the vehicle 11 to a position where the automated valet parking is possible. The position where the automated valet parking is possible is one of the entrance and exit room 13.

In A12, the infrastructure 32 guides the user and the vehicle 11 to a position where the automated valet parking is possible. For example, an electronic display board included in the infrastructure 32 displays, to the user, a room number of the entrance and exit room 13 to be entered.

In A13, the user stops the vehicle 11 at a position where the automated valet parking is possible, and gets off the vehicle 11.

In A14, the user inputs information to the individual terminal 27. The information includes existence of reservation, reservation number when the reservation exists, parking method, entrance request, exit reservation, or the like. The information about exit reservation includes the scheduled exit time. The parking method is either robot parking or parking using the AVP function. The smartphone may be configured to enable the user input the information to the smartphone.

In A15, the individual terminal 27 transmits the information input in A14 to the control device 25. When the information is input to the smartphone, the smartphone may transmit the information input in A14 to the control device 25.

When the user selects parking using the AVP function, the process executes A16 to A19. When the user selects the robot parking, the process does not execute A16 to A19.

In A16, the control device 25 requests the vehicle 11 to check matching between the automated valet parking lot 1 and the vehicle 11. In above-described A3, when that the automated valet parking lot 1 has already been determined to match with the vehicle 11, the process may omit A16 by not executing A16.

In A17, the vehicle 11 transmits an answer to the control device 25. The answer may indicate that the parking lot matches with the vehicle 11, or may indicate that the automated valet parking lot 1 does not match with the vehicle 11. When the answer indicates that the automated valet parking lot 1 does not match with the vehicle 11, the process executes A18 and A19. When the answer indicates that the automated valet parking lot 1 matches with the vehicle 11, the process does not execute A18 and A19.

In A18, the control device 25 notifies the individual terminal 27 that the automated valet parking lot 1 does not match with the vehicle 11 and that the parking method is set to the robot parking. The control device 25 may notify the same information to the smartphone.

In A19, the individual terminal 27 notifies the user that the automated valet parking lot 1 does not match with the vehicle 11, and the parking method is set to the robot parking. The smartphone may notify the same information to the user.

In A20, the control device 25 requests the infrastructure 32 to check whether a size of the vehicle 11 is allowable. In addition to or instead of the size of the vehicle, the infrastructure may check whether another parameter of vehicle 11 are allowable. The term “allowable” indicates that the automated valet parking can be performed in the automated valet parking lot 1.

In A21, the infrastructure 32 checks whether the size of the vehicle 11 is allowable, and transmits a check result to the control device 25.

When the check result in A21 indicates that the size of the vehicle 11 is not allowed, the process executes A22 and A23, and the cycle of current process is finished. When the check result in A21 indicates that the size of the vehicle 11 is allowed, the process does not execute A22 and A23, and proceeds to A24.

In A22, the control device 25 notifies the individual terminal 27 that the automated valet parking is not available since the size of the vehicle 11 does not match with the parking lot. The control device 25 may notify the same information to the smartphone.

In A23, the individual terminal 27 notifies the user that automated valet parking is not available because the size of the vehicle 11 does not match with the parking lot. The individual terminal 27 requests the user to move to a different parking lot. The smartphone may notify and request the user to move to a different parking lot. The individual terminal 27 may display a message requesting the user to return to the vehicle 11 parked in the entrance and exit room 13.

In A24, the control device 25 notifies the individual terminal 27 of a start of vehicle entrance. The control device 25 may notify the same information to the smartphone.

In A25, the individual terminal 27 notifies the user of the start of vehicle entrance. The smartphone may notify the same information to the user.

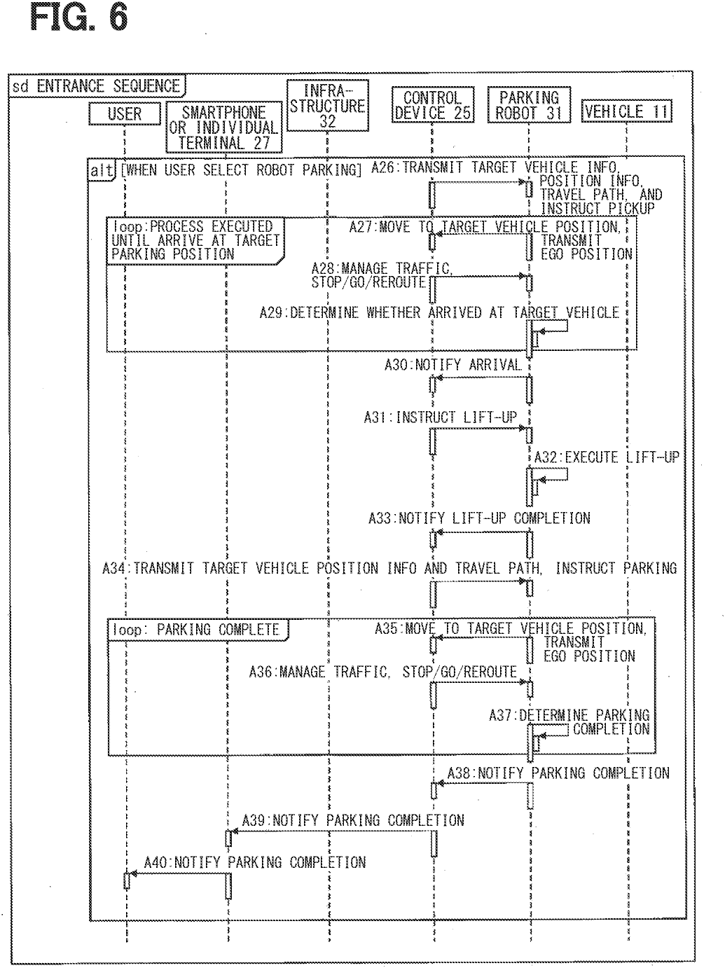

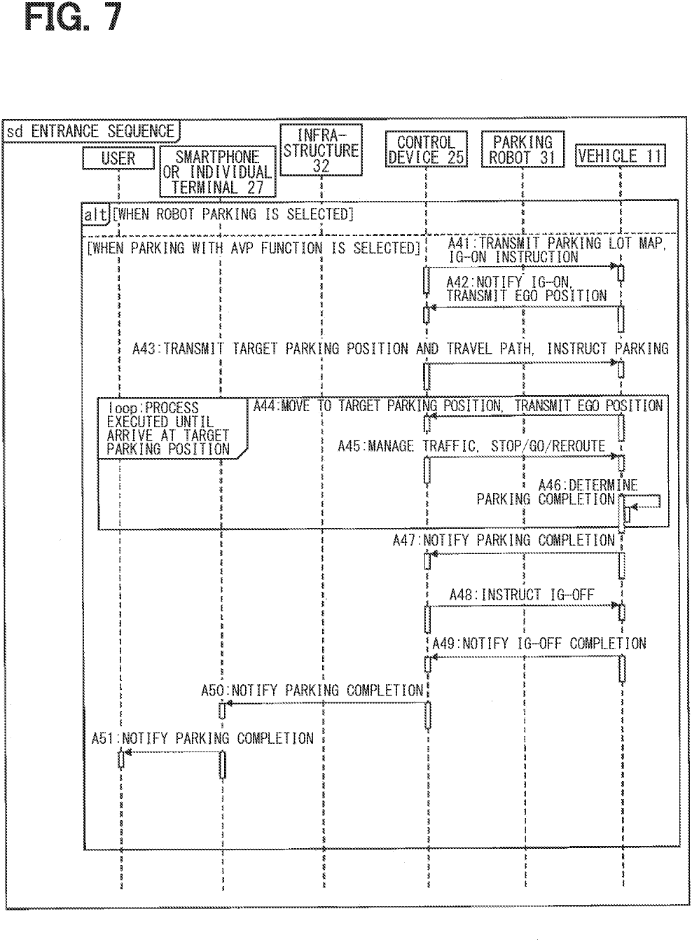

When the user selects the robot parking, or when the robot parking is notified in A19, the process executes A26 to A40 shown in FIG. 6. When the user selects parking using the AVP function and the robot parking is not notified in A19, the process executes A41 to A51 shown in FIG. 7.

In A26, the control device 25 transmits, to the parking robot 31, target vehicle information, position information, a travel path, and a pick-up instruction. The target vehicle information is information about a target vehicle. In the present embodiment, the target vehicle is the vehicle 11 to be parked in the parking lot. The position information indicates a current position of the target vehicle. The travel path is a path from a current position of the parking robot 31 to the current position of the target vehicle. The pick-up instruction instructs the parking robot to pick up the target vehicle.

The process repeatedly executes A27 to A29 until the parking robot 31 arrives in front of the target vehicle. In A27, the parking robot 31 moves toward the target vehicle position, and transmits the current position of the parking robot 31 to the control device 25.

In A28, the control device 25 manages traffic based on the current position of the parking robot 31 received in A27. The control device 25 transmits instructions for stopping, starting, and rerouting to the parking robot 31 as necessary. The parking robot 31 stops, starts, and reroutes in response to the instructions.

In A29, the parking robot 31 determines whether the parking robot 31 has arrived in front of the target vehicle. When the parking robot 31 has not yet arrived in front of the target vehicle, the process returns to A27. When the parking robot 31 has arrived in front of the target vehicle, the process finishes A27 to A29, and then proceeds to A30.

In A30, the parking robot 31 notifies the control device 25 that the parking robot 31 has arrived in front of the target vehicle.

In A31, the control device 25 instructs the parking robot 31 to lift up the target vehicle.

In A32, the parking robot 31 lifts up the target vehicle. When the lift-up is completed, the process proceeds to A33.

In A33, the parking robot 31 notifies the control device 25 that lift-up of the target vehicle is completed.

In A34, the control device 25 sets the target parking position. The target parking position is a parking position where the vehicle 11 is to be parked. The target parking position is included in the parking space 7. A method of setting the target parking position will be described later.

In A34, the control device 25 transmits target parking position information, a travel path, and a parking instruction to the parking robot 31. The target parking position information indicates information about the target parking position. The travel path is a path from the current position of the parking robot 31 to the target parking position. The parking instruction is an instruction for parking the target vehicle at the target parking position.

The process repeatedly executes A35 to A37 until the parking robot 31 arrives at the target parking position. In A35, the parking robot 31 travels toward the target parking position, and transmits the current position of the parking robot 31 to the control device 25.

In A36, the control device 25 manages traffic based on the position of the parking robot 31 received in A35. The control device 25 transmits instructions for stopping, starting, and rerouting to the parking robot 31 as necessary. The parking robot 31 stops, starts, and reroutes in response to the instructions.

In A37, the parking robot 31 determines whether the parking robot 31 has arrived at the target parking position. When the parking robot 31 has not yet arrived at the target parking position, the process returns to A35. When the parking robot 31 arrives at the target parking position, the process finishes A35 to A37, then proceeds to A38. When the parking robot 31 arrives at the target parking position, the parking robot 31 lifts down the target vehicle.

In A38, the parking robot 31 notifies the control device 25 of a completion of parking.

In A39, the control device 25 notifies the individual terminal 27 of the completion of parking. The control device 25 may notify the smartphone of the completion of parking.

In A40, the individual terminal 27 notifies the user of the completion of parking. The smartphone may notify the user of the completion of parking.

In A41, the control device 25 transmits a parking lot map to the vehicle 11, and transmits an ignition-on instruction to the vehicle 11. The parking lot map indicates map information of the automated valet parking lot 1. The ignition-on instruction is an instruction for turning on an ignition of the vehicle 11. The vehicle 11 receives the parking lot map. The vehicle 11 turns on the ignition in response to the ignition-on instruction.

In A42, the vehicle 11 transmits an ignition-on notification and ego position to the control device 25. The ignition-on notification indicates that the ignition of vehicle 11 is turned on. The ego position is the current position of the vehicle 11.

In A43, the control device 25 sets the target parking position. The target parking position is included in the parking space 7. A method of setting the target parking position will be described later. The control device 25 transmits target parking position information, a travel path, and a parking instruction to the vehicle 11. The travel path is a path from the current position of the vehicle 11 to the target parking position. The parking instruction is an instruction for moving along the travel path and parking the target vehicle at the target parking position.

The process repeatedly executes A44 to A46 until the vehicle 11 arrives at the target parking position. In A44, the vehicle 11 travels toward the target parking position and transmits the current position of the vehicle 11 to the control device 25.

In A45, the control device 25 manages traffic based on the current position of the vehicle 11 received in A44. The control device 25 transmits instructions for stopping, starting, and rerouting to the vehicle 11 as necessary. The vehicle 11 stops, starts, and reroutes in response to the instructions.

In A46, the vehicle 11 determines whether the vehicle 11 has arrived at the target parking position. When the vehicle 11 has not yet arrived at the target parking position, the process returns to A44. When the vehicle 11 arrives at the target parking position, the process finishes A44 to A46, then proceeds to A47.

In A47, the vehicle 11 notifies the control device 25 of a completion of parking.

In A48, the control device 25 instructs the vehicle 11 to turn off the ignition. In response to the instruction, the vehicle 11 turns off the ignition.

In A49, the vehicle 11 notifies the control device 25 of a completion of ignition-off.

In A50, the control device 25 notifies the individual terminal 27 of the completion of parking. The control device 25 may notify the smartphone of the completion of parking.

In A51, the individual terminal 27 notifies the user of the completion of parking. The smartphone may notify the user of the completion of parking.

Specifically, the parking assist unit 47 of the control device 25 executes the process, which is described as being executed by the control device 25 in the above description. The parking assist unit 47 provides various instructions and information necessary for the parking robot 31 or the vehicle 11A with the AVP function to travel from the entrance and exit room 13 to the target parking position. Examples of the instructions include the above-described pick-up instruction, instructions for stopping, starting, and rerouting, the lift-up instruction, the parking instruction, the ignition-on instruction, and the ignition-off instruction. Examples of the information include position information of the target vehicle, the travel path, the target parking position information, and the parking lot map.

### 4. Exit Related Process Executed by Control System 23 and Exit Request Vehicle

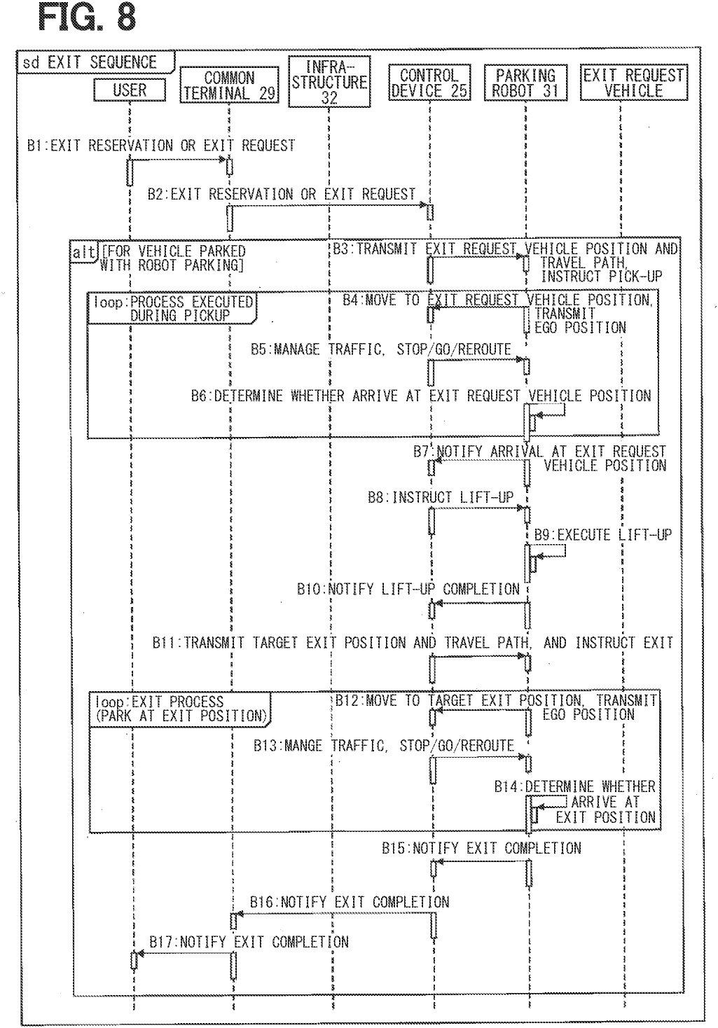

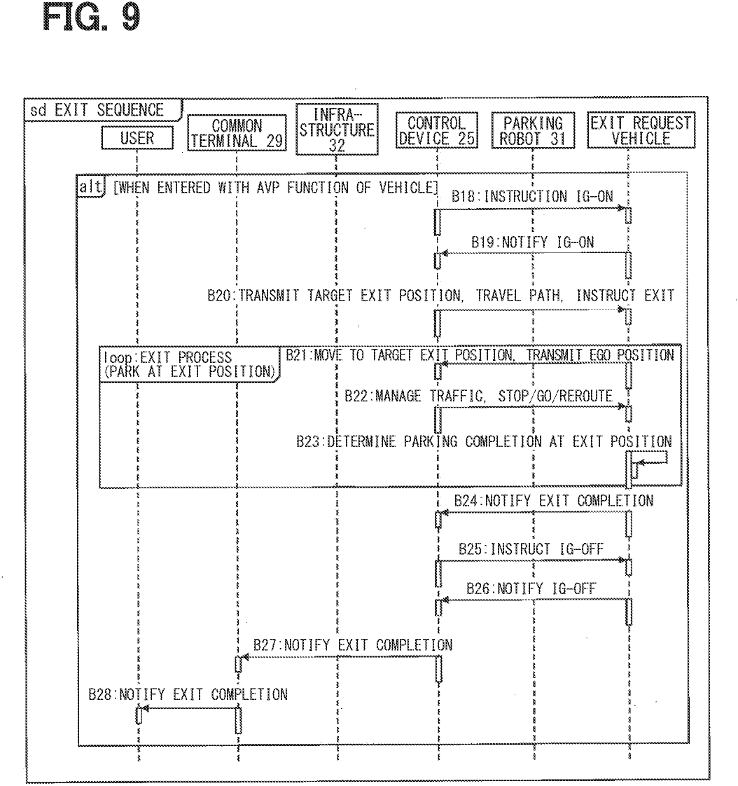

The following will describe an exit related process executed by control system 23 and exit request vehicle with reference to FIG. 8 and FIG. 9.

In B1, the user inputs an exit reservation or an exit request to the common terminal 29. The user inputs, to the common terminal 29, identification information of the user and identification information of the exit request vehicle. The exit request vehicle is the vehicle 11 which is requested to exit by the exit request.

In B2, the common terminal 29 transmits the exit reservation or the exit request to the control device 25. When the common terminal 29 transmits the exit reservation and when the exit reservation is entered in A1 or A14, the following process is executed according to the scheduled exit time. When the common terminal 29 transmits the exit request, the following processing is immediately executed.

When the exit request vehicle is parked by the robot parking, the process executes B3 to B17. When the exit request vehicle 11 is parked by the AVP function of the exit request vehicle, the process executes B18 to B28.

In B3, the control device 25 transmits an exit request vehicle position, a travel path, and a pick-up instruction to the parking robot 31. The exit request vehicle position is the current position of the exit request vehicle. The travel path is a path from a current position of the parking robot 31 to the current position of the exit request vehicle. The pick-up instruction instructs the parking robot to pick up the exit request vehicle.

The process repeatedly executes B4 to B6 until the parking robot 31 arrives at the exit request vehicle position. In B4, the parking robot 31 travels toward the exit request vehicle position, and transmits the current position of the parking robot 31 to the control device 25.

In B5, the control device 25 manages traffic based on the current position of the parking robot 31 received in B4. The control device 25 transmits instructions for stopping, starting, and rerouting to the parking robot 31 as necessary. The parking robot 31 stops, starts, and reroutes in response to the instructions.

In B6, the parking robot 31 determines whether the parking robot 31 has arrived at the exit request vehicle position. When the parking robot 31 has not yet arrived at the exit request vehicle position, the process returns to B4. When the parking robot 31 arrives at the exit request vehicle position, the process finishes B4 to B6, and then proceeds to B7.

In B7, the parking robot 31 notifies the control device 25 that the parking robot 31 has arrived at the exit request vehicle position.

In B8, the control device 25 instructs the parking robot 31 to lift up the exit request vehicle.

In B9, the parking robot 31 lifts up the exit request vehicle. When the lift-up is completed, the process proceeds to B10.

In B10, the parking robot 31 notifies the control device 25 of the completion of lift-up.

In B11, the control device 25 transmits a target exit position information, a travel path, and an exit instruction to the parking robot 31. A target exit position is one of the entrance and exit rooms 13. The target exit position information is position information indicating the target exit position. The travel path is a path from the current position of the parking robot 31 to the target exit position. The exit instruction is an instruction to move the exit request vehicle to the target exit position.

The process repeatedly executes B12 to B14 until the parking robot 31 arrives at the target exit position. In B12, the parking robot 31 moves toward the target exit position and transmits the current position of the parking robot 31 to the control device 25.

In B13, the control device 25 manages traffic based on the position of the parking robot 31 received in B12. The control device 25 transmits instructions for stopping, starting, and rerouting to the parking robot 31 as necessary. The parking robot 31 stops, starts, and reroutes in response to the instructions.

In B14, the parking robot 31 determines whether the parking robot 31 has arrived at the target exit position. When the parking robot 31 has not yet arrived at the target exit position, the process returns to B12. When the parking robot 31 has arrived at the target exit position, the process finishes B12 to B14, and then proceeds to B15. When the parking robot 31 arrives at the target exit position, the parking robot 31 lifts down the exit request vehicle.

In B15, the parking robot 31 notifies the control device 25 of the completion of exit.

In B16, the control device 25 notifies the common terminal 29 of the completion of exit. The control device 25 may notify the smartphone of the completion of exit.

In B17, the common terminal 29 notifies the user of the completion of unloading. The smartphone may notify the user of the completion of unloading.

In B18, the control device 25 transmits an ignition-on instruction to the exit request vehicle. The exit request vehicle turns on the ignition in response to the ignition-on instruction.

In B19, the exit request vehicle transmits an ignition-on notification to the control device 25.

In B20, the control device 25 transmits a target exit position, a travel path, and an exit instruction to the exit request vehicle. The travel path is a path from the current position of the exit request vehicle to the target exit position.

The process repeatedly executes B21 to B23 until the exit request vehicle arrives at the target exit position. In B21, the exit request vehicle travels toward the target exit position, and the current position of the exit request vehicle is transmitted to the control device 25.

In B22, the control device 25 manages traffic based on the current position of the exit request vehicle received in B21. The control device 25 transmits instructions for stopping, starting, and rerouting to the exit request vehicle as necessary. The exit request vehicle stops, starts, and reroutes in response to the instructions.

In B23, the exit request vehicle determines whether the exit request vehicle has arrived at the target exit position. When the exit request vehicle has not yet arrived at the target exit position, the process returns to B21. When the exit request vehicle has arrived at the target exit position, the process finishes B21 to B23, and then proceeds to B24.

In B24, the exit request vehicle notifies the control device 25 of the completion of exit.

In B25, the control device 25 instructs the exit request vehicle to turn off the ignition. The exit request vehicle turns off the ignition.

In B26, the exit request vehicle notifies the control device 25 of the completion of ignition-off.

In B27, the control device 25 notifies the common terminal 29 of the completion of exit. The control device 25 may notify the smartphone of the completion of exit.

In B28, the common terminal 29 notifies the user of the completion of exit. The smartphone may notify the user of the completion of exit.

When the user does not get into the vehicle 11 or when the user is not detected in the entrance and exit room 13 even after a predetermined period has elapsed since the vehicle 11 arrived at the target exit position, the control device 25 may park the vehicle 11 again in a proper position. For example, the proper position where the vehicle 11 is to be parked again may be a back area AF, which will be described later, or a parking space dedicated to the vehicle 11 to be parked again.

### 5. Target Parking Position Setting Process Executed by Control Device 25

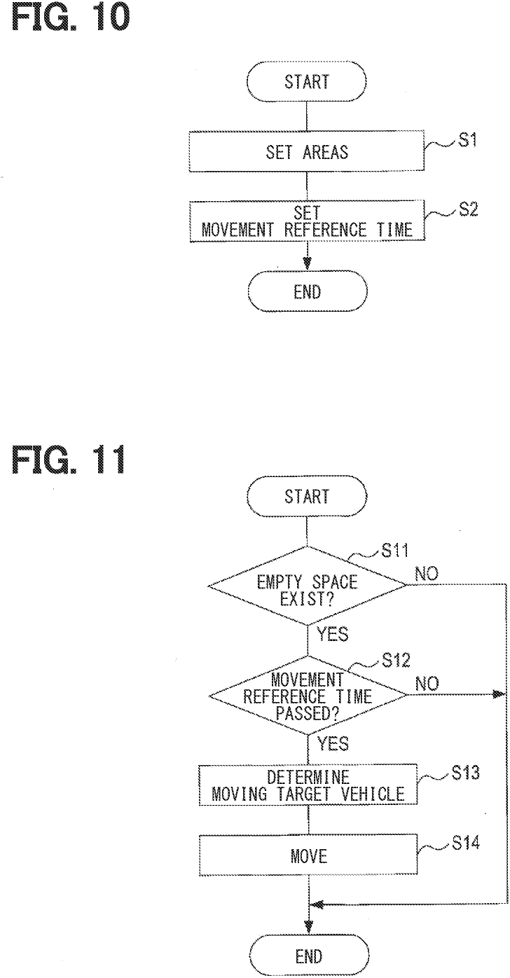

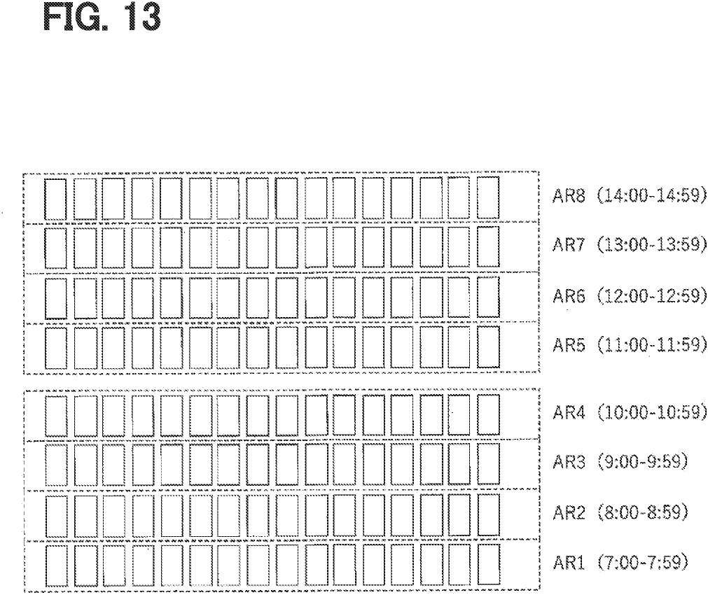

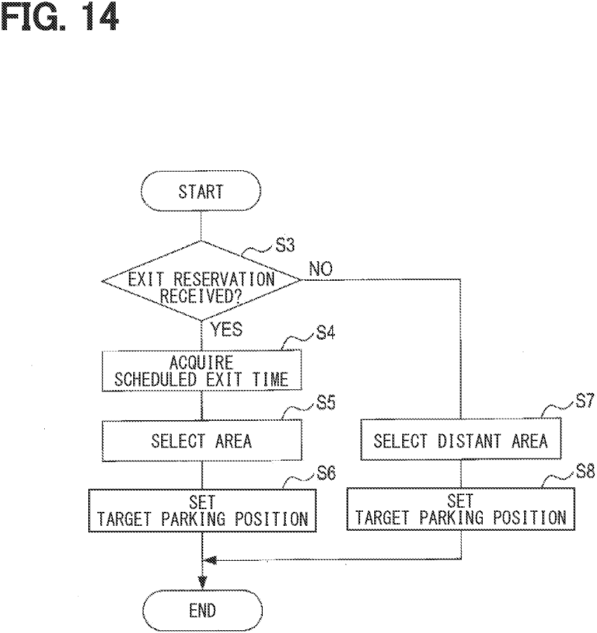

The following will describe the process for setting area and the process for setting target parking position by the control device 25 in A34 and A43 with reference to FIG. 1, FIG. 10, FIG. 13, and FIG. 14.

The process shown in FIG. 10 is an area setting process. The control device 25 executes the area setting process at predetermined time intervals when the control device 25 is in activated state. The area setting unit 40 sets multiple areas AR1 to AR8, which are shown in FIG. 1, in S1 of the area setting process shown in FIG. 10. The areas AR1 to AR8 correspond to time related areas. The areas AR1 to AR8 are defined in the parking space 7. FIG.

The vehicle 11 parked in the area ARi travels to one of the entrance and exit rooms 13, and the travel distance is defined as Di. Herein, i is a natural number from 1 to 8. A smaller value of i indicates a shorter distance Di. That is, D1 is the shortest distance, and D2, D3, D4, D5, D6, D7, and D8 are increased in the described order.

The area ARi is closer to the entrance and exit room 13 than the area AR(i+1). The travel distance from a reference position included in the area ARi to the entrance and exit room 13 is shorter than the travel distance from a reference position included in the area AR(i+1) to the entrance and exit room 13.

The area setting unit 40 correlates each of the areas AR1 to AR8 with a scheduled exit time. The area setting unit 40 correlates each area ARi with the scheduled exit time, which is set within a range from time ti to time t(i+1). Herein, ti indicates a time earlier than t(i+1). The correlated scheduled exit time differs for each area ARi.

As described above, when the value of i decreases, the scheduled exit time correlated with the area ARi is set as an earlier time. When the value of i decreases, the travel distance Di is shortened. Therefore, the earlier the scheduled exit time correlated with an area ARi, the shorter the travel distance Di from the area ARi to the entrance and exit room.

In the example shown in FIG. 1, the areas ARi have a belt-like shape extending parallel to a direction in which the entrance and exit rooms 13 are arranged. The areas ARi may be defined in a different manner. For example, the areas ARi may have a belt-like shape extending in a direction perpendicular to an arrangement direction of the entrance and exit rooms 13, or may have a belt-like shape extending in a direction oblique to the arrangement direction of the entrance and exit rooms 13. The number of areas ARi may be other than 8, and may be set as appropriate. All of the areas ARi may have the same size. Alternatively, the areas Ari may have different sizes from one another.

FIG. 13 shows a setting example of the areas AR1 to AR8. In the example shown in FIG. 13, the current time is 7:00. The area setting unit 40 correlates, for example, the area AR1 with the scheduled exit time of 7:00. The scheduled exit time of 7:00 indicates a time point within a range from 7:00 to 7:59. The area setting unit 40 correlates each of the areas AR2 to AR8 with the scheduled exit time shown in FIG. 13.

For example, the vehicle 11 whose scheduled exit time is 7:30 is parked in the area AR1. When the current time approaches 7:30, the control device 25 starts the exit process of the vehicle 11 from the area AR1.

For example, the scheduled exit time correlated with the area ARi changes over time. For example, in the example shown in FIG. 13, when the current time is 7:00, the scheduled exit time correlated with the area AR1 is from 7:00 to 7:59. When the current time is 8:00, the scheduled exit time correlated with the area AR1 is from 8:00 to 8:59.

In S2, the reference setting unit 46 sets a movement reference time tsi for each area ARi. That is, the movement reference time of the areas AR1 to AR8 are set as ts1 to ts8, respectively. When the value of i decreases, the movement reference time tsi indicates an earlier time.

For example, a duration required to move the vehicle 11 from the area AR(i+1) to the area ARi is defined as ΔT. The movement reference time tsi is set to be earlier than the scheduled exit time, which is correlated with the area ARi, by the duration ΔT or more. For example, the duration ΔT required to move the vehicle 11 from the area AR2 to the area AR1 may be set to 9 minutes. In this case, the scheduled exit time correlated with area AR1 is from 7:00 to 7:59. Thus, the movement reference time ts1 may be set as a time earlier than 7:59 by 9 minutes or more. For example, the movement reference time ts1 may be set to 7:45.

The movement reference time tsi is set within a range of the scheduled exit time that is correlated with the area ARi. By setting the movement reference time tsi for the area ARi, even if there is an empty space 51 in the area ARi, the vehicle 11 with a late scheduled exit time is not parked in the empty space 51 until the current time reaches movement reference time tsi. The empty space 51 in the area ARi continues the available state until the current time reaches the movement reference time tsi. With this configuration, it is possible to prevent a situation in which parking of new vehicle in the area ARi becomes difficult due to moving the vehicle 11 to the empty space 51 of the area ARi.

FIG. 14 shows a target parking position setting process. For example, in A15, when the individual terminal 27 or the smartphone transmits a parking request to the control device 25, the control device 25 executes the target parking position setting process. As shown in FIG. 14, the time acquisition unit 41 determines, in S3, whether the control device 25 has received the exit reservation for the vehicle 11, which is scheduled to be parked. For example, the exit reservation may be input to the smart phone as described in A1. The smart phone transmits the exit reservation to the control device 25. For example, the exit reservation may be input to the individual terminal 27 as described in A14. The individual terminal 27 transmits the exit reservation to the control device 25.

When the control device 25 has received the exit reservation, the process proceeds to S4. When the control device 25 has not received the exit reservation, the process proceeds to S7. A case where the control device 25 has not received the exit reservation corresponds to a case where the scheduled exit time of the vehicle 11 cannot be acquired.

In S4, the time acquisition unit 41 acquires the scheduled exit time included in the exit reservation. The scheduled exit time to be acquired is the scheduled exit time of the vehicle 11, which is scheduled to be parked in the parking lot.

In S5, the area selection unit 42 selects, among the areas AR1 to AR8, one area ARi corresponding to the scheduled exit time acquired in S4. The scheduled exit time acquired in S4 is included in a range of the scheduled exit time correlated to the selected area ARi. As described above, the range of scheduled exit time of the area ARi is set from ti to t(i+1).

In S6, the parking position setting unit 43 sets the target parking position within the area ARi selected in S5.

In S7, the area selection unit 42 selects a distant area AF. As shown in FIG. 1, the distant area AF is located distant from the entrance and exit room 13 in the parking space 7. When the target parking position is set within the distant area AF, the travel distance from the target parking position to any one of the entrance and exit rooms 13 is longer than any one of the distances D1 to D8.

In S8, the parking position setting unit 43 sets the target parking position within the distant area AF selected in S7.

### 6. Parked Vehicle Moving Process Executed by Control Device 25

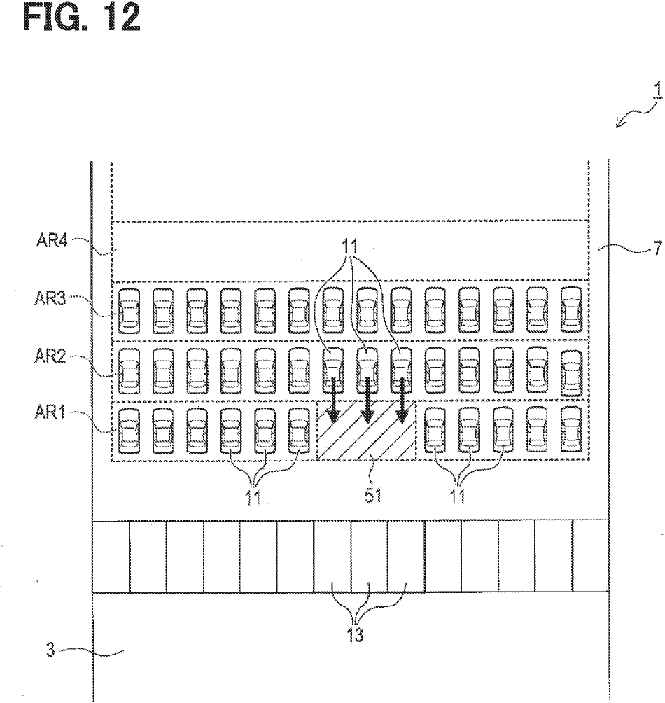

The following will describe a parked vehicle moving process, which is executed by the control device 25 at predetermined intervals, with reference to FIG. 11 and FIG. 12. For example, when the control device 25 detects (i) that the vehicle 11 parked in the parking space 7 starts traveling toward the entrance and exit room 13, or (ii) that the parking robot 31 starts transporting the vehicle 11, the control device executes the parked vehicle moving process.

In S11 of FIG. 11, the empty space determination unit 44 determines whether an empty space 51 exists in any one of the areas AR1 to AR7. The empty space 51 is a space in which the vehicle 11 can be parked. FIG. 12 shows an example of the empty space 51. In the example shown in FIG. 12, the empty space 51 is located in the area AR1.

When there is an empty space 51 in any of the areas AR1 to AR7, the process proceeds to S12. When there is no empty space 51 in any of the areas AR1 to AR7, the process is ended.

In S12, the empty space determination unit 44 first out the movement reference time tsi of the area ARi (hereinafter referred to as a destination area) in which existence of the empty space 51 is determined in S11. In the example shown in FIG. 12, the area AR1 corresponds to the destination area. In the example shown in FIG. 12, the movement reference time of the area AR1 is read out by the empty space determination unit.

Then, the empty space determination unit 44 determines whether the current time has already passed the movement reference time tsi of the destination area. When the current time has already passed the movement reference time tsi of the destination area, the process proceeds to S13. When the current time has not yet passed the movement reference time tsi of the destination area, the process is ended.

In S13, the moving unit 45 determines the vehicle 11 (hereinafter referred to as a movement target vehicle) to be moved to the empty space 51 from the vehicles 11 parked in the parking space 7. In the example shown in FIG. 12, the movement target vehicle is determined as the vehicle 11 parked in the area A2.

The moving unit 45 may determine the movement target vehicle based on the position of the vehicle 11 parked in the parking space 7, the scheduled exit time of the vehicle 11 parked in the parking space 7, the empty space in the parking space 7.

The moving target vehicle is a vehicle 11 that satisfies a predetermined moving condition. Examples of the movement condition may include the following conditions J1 to J5.

### Moving Condition J1

The moving target vehicle is set as the vehicle 11 parked in another area ARi with scheduled exit time being later than that of the destination area.

### Moving Condition J2

There is one area ARi in which the scheduled exit time is later than the destination area and the number of parked vehicles 11 is equal to or less than a preset threshold number. All of the vehicles 11 parked in the one area ARi may be set as the moving target vehicles.

### Moving Condition J3

The moving target vehicle is set as the vehicle 11 parked in another area ARi with scheduled exit time being later than that of the destination area. The travel distance from the moving target vehicle to the entrance and exit room 13 is required to be equal to or greater than a preset threshold distance. In addition, a duration from the current time to the scheduled exit time of the moving target vehicle is required to be within a preset threshold duration.

The travel distance from the moving target vehicle to the entrance and exit room 13 is defined as the traveling distance from the parking position of the moving target vehicle before moving to the destination area to the entrance and exit room 13. The parking position of the moving target vehicle before moving to the destination area is defined as the parking position of the moving target vehicle at the current time.

### Moving Condition J4

The moving target vehicle is set as the vehicle 11 parked in one area ARi with scheduled exit time immediately later than that of the destination area. That is, when the moving target vehicle is parked in the area ARi, the destination area is set as AR(i+1).

### Moving Condition J5

The moving target vehicle is set as the vehicle 11 parked in another area ARi with scheduled exit time being later than that of the destination area. The area ARi in which the moving target vehicle is parked is adjacent to the destination area. For example, the area ARi in which the moving target vehicle is parked is adjacent to the destination area in the longitudinal direction of the empty space 51 existing in the destination area.

The moving condition is, for example, any one of the above-described moving conditions J1 to J5. As another example, the moving condition may be set to satisfy two or more of the above-described moving conditions J1 to J5. As another example, the moving condition may be set to satisfy one or more condition when two or more of the above-described moving conditions J1 to J5 are selected.

The number of moving target vehicles may be set within a range equal to or less than the number of vehicles that can be parked in the empty space 51. When the moving target vehicles are determined by the moving condition J2, all of the vehicles 11 parked in the area ARi correspond to the moving target vehicles.

The number of moving target vehicles may be set to a fixed number to be less than the number of vehicles that can be parked in the empty space 51. For example, the fixed number is determined according to the number of vehicles that can be parked in the empty space 51.

In S14, the moving unit 45 moves the mobile target vehicle determined in S13 to the empty space 51. As a method of moving the moving target vehicle to the empty space 51, for example, the parking robot 31 may transport the moving target vehicles to the empty space 51. The method of moving the moving target vehicle by the parking robot 31 is basically the same as the process executed in A26 to A38. In this moving, the parking position after moving is a parking position within the empty space 51.

As a method of moving the moving target vehicle to the empty space 51, for example, the AVP function of the moving target vehicle may be used to perform the autonomous driving. The method of moving the moving target vehicle by performing the autonomous driving is basically the same as the process executed in A41 to A49. In this moving, the parking position after the autonomous driving is a parking position within the empty space 51.

### 7. Effects of Control Device 25

(1A) The control device 25 sets multiple areas ARi within the parking space 7. The multiple areas ARi are correlated with different scheduled exit times. The earlier the scheduled exit time correlated with one area ARi, the shorter the travel distance Di from the one area ARi to the entrance and exit room.

The control device 25 acquires the scheduled exit time of the vehicle 11, which is scheduled to be parked in the parking lot. The control device 25 selects one area ARi corresponding to the acquired scheduled exit time. The control device 25 sets the parking position of the vehicle 11 within the selected area ARi.

With above configuration, the control device 25 can park the vehicle 11 having the early scheduled exit time in the area ARi having the short travel distance Di. As a result, the control device 25 can control the vehicle 11 having the early scheduled exit time to exit from parking lot within a short period of time.

(1B) The control device 25 determines whether an empty space 51 exists in one of the areas ARi. In response to determining an empty space 51 exists in one of the areas (also referred to as destination area), the control device 25 moves the vehicle 11 parked in another area ARi whose scheduled exit time is later than the scheduled exit time of the destination area to the empty space 51 existing in the destination area. Therefore, the control device 25 can shorten the time required for the vehicle 11, which is moved to the empty space 51, to exit the parking lot.

(1C) The number of moving target vehicles may be set to the number of vehicles that can be parked in the empty space 51, or may be set to a fixed number. As the number of moving target vehicles increases, for each of the moving target vehicles 11, the time required for exit from the parking lot can be shortened. If the fixed number of moving target vehicles is less than the number of vehicles that can be parked in the empty space 51, the remaining space can be left tin the destination area for later parking of other vehicles.

(1D) The control device 25 can set the vehicle 11 that satisfies the moving condition J2 described above as the moving target vehicle. In this case, the control device 25 can move all of the vehicles 11 parked in an area ARi to the empty space 51.

(1E) The control device 25 can set the vehicle 11 that satisfies the moving condition J3 described above as the moving target vehicle. In this case, the control device 25 can perform highly effective moving to the vehicle 11 which is moved from the current position to the empty space 51.

(1F) The control device 25 sets the movement reference time tsi for each area ARi. The control device 25 moves the moving target vehicle to the empty space 51 under a condition that the moving reference time tsi of the destination area has already passed. With this configuration, after moving the moving target vehicle to the empty space 51 of the destination area, it is possible to prevent a situation in which parking of new vehicle in the destination area becomes difficult due to the moving of the target vehicle to the destination area.

(1G) The control device 25 can set the vehicle 11 that satisfies the moving condition J4 described above as the moving target vehicle. In this case, the control device 25 can decrease the moving distance of the moving target vehicle.

(1H) When the control device 25 cannot acquire the scheduled exit time of the vehicle 11 scheduled to park in the parking lot, the control device sets the parking position in the distant area AF. Therefore, the control device 25 can prevent the area ARi from being occupied by the vehicle 11 from which the scheduled exit time cannot be obtained.

### Other Embodiments

Although the embodiments of the present disclosure have been described above, the present disclosure is not limited to the embodiments described above, and various modifications can be made to implement the present disclosure.

(1) The determination in S12 may be a determination as to whether a duration from the current time to the movement reference time tsi of the destination area is equal to or shorter than a predetermined duration. When the duration from the current time to the movement reference time tsi of the destination area is equal to or shorter than the predetermined duration, the process proceeds to S13. When the duration from the current time to the movement reference time tsi of the destination area is longer than the predetermined duration, the process is ended. With this configuration, the above-described effect (1G) can be obtained. For example, when the current time has already passed the movement reference time tsi of the destination area, it can be considered that the duration from the current time to the movement reference time tsi of the destination area is equal to or shorter than the predetermined duration.

(2) When the determination “YES” is made in S11, the process may directly proceed to S13. That is, the process may omit S12. In this configuration, the control device can also provide the above-described effects (1A), (1B), (1C), (1D), (1E), (1G), and (1H).

(3) The control unit 33 and the method described in the present disclosure may be implemented by a special purpose computer, which includes a memory and a processor programmed to execute one or more special functions implemented by computer programs of the memory. Alternatively, the control unit 33 and the method described in the present disclosure may be implemented by a dedicated computer configured as a processor with one or more dedicated hardware logic circuits. Alternatively, the control unit 33 and the method thereof described in the present disclosure may be implemented by one or more dedicated computers configured by a combination of a processor and a memory programmed to execute one or multiple functions and a processor configured by one or more hardware logic circuits. The computer program may also be stored in a computer readable non-transitory tangible storage medium as computer executable instructions. The control unit 33 and the method thereof described in the present disclosure does not necessarily need to include software, and all the functions may be implemented using one or more hardware circuits.

(4) Multiple functions of one configuration element in the above embodiments may be implemented by multiple configuration elements, or a single function of one configuration element may be implemented by multiple configuration elements. Multiple functions of multiple configuration elements in the above embodiments may be implemented by one configuration element, or one function implemented by multiple configuration elements may be implemented by one configuration element. A part of the configurations of the above embodiments may be omitted as appropriate. At least a part of the configuration in one embodiment may be added to or substituted for the configuration of another embodiment.

(5) In addition to the above control device 25, the present disclosure can also be implemented in various forms, such as a system including the control device 25 as an element, a program that controls a computer to function as the control unit 33 of the control device 25, a non-transitory tangible storage medium, such as a semiconductor memory in which the above-described program is recorded, and an automatic parking assist method.

What is claimed is:

1. A control device used in an automated valet parking lot, the automated valet parking lot including an entrance room, an exit room, and a parking space, the control device comprising:
an area setting unit setting a plurality of time related areas in the parking space, the plurality of time related areas being correlated to respective scheduled exit times different from one another;
a time acquisition unit acquiring a scheduled exit time of a vehicle to be parked in the automated valet parking lot;
an area selection unit selecting, from the plurality of time related areas, a target parking area of the vehicle corresponding to the scheduled exit time acquired by the time acquisition unit; and
a parking position setting unit setting a parking position in the target parking area, which is selected by the area selection unit,
wherein the area setting unit sets each of the plurality of time related areas to have a shorter travel distance to the exit room than other time related areas when the correlated scheduled exit time is earlier than those of other time related areas.

2. The control device according to claim 1, further comprising:
an empty space determination unit determining whether an empty space exists in one of the plurality of time related areas; and
a moving unit, in response to determining an existence of the empty space in the one of the plurality of time related areas, moving a vehicle parked in another one of the plurality of time related areas to the one of the plurality of time related areas, wherein the scheduled exit time correlated to the another one of the plurality of time is later than the scheduled exit time correlated to the one of the plurality of time related areas.

3. The control device according to claim 2, wherein
a quantity of vehicles moved to the empty space by the moving unit is set to be equal to a quantity of vehicles that can be parked in the empty space, or is set to a fixed quantity.

4. The control device according to claim 2, wherein,
when a quantity of vehicles that can be parked in the another one of the plurality of time related areas, which is correlated to the scheduled exit time later than the scheduled exit time of the one of the plurality of time related areas, is set to be equal to or less than a predetermined threshold, the moving unit moves all of vehicles parked in the another one of the plurality of time related areas to the empty space of the one of the plurality of time related areas.

5. The control device according to claim 2, wherein
the moving unit moves the vehicle parked in the another one of the plurality of time related areas to the empty space of the one of the plurality of time related areas when (i) a travel distance from the vehicle to the exit room is equal to or longer than a predetermined threshold distance, and (ii) a duration from a current time to the scheduled exit time of the vehicle is within a predetermined threshold duration.

6. The control device according to claim 2, further comprising
a reference setting unit setting a movement reference time to each of the plurality of time related areas,
wherein the moving unit moves the vehicle parked in the another one of the plurality of time related areas to the empty space of the one of the plurality of time related areas when (i) the movement reference time of the one of the plurality of time related areas, which has the empty space, has already passed or (ii) a duration from the current time to the movement reference time of the one of the plurality of time related areas is equal to or shorter than a predetermined threshold duration.

7. The control device according to claim 2, further comprising
a reference setting unit setting a movement reference time to each of the plurality of time related areas, wherein
the moving unit does not move the vehicle parked in the another one of the plurality of time related areas to the empty space of the one of the plurality of time related areas when the movement reference time of the one of the plurality of time related areas, which has the empty space, has not yet passed, and
the moving unit moves the vehicle parked in the another one of the plurality of time related areas to the empty space of the one of the plurality of time related areas when the movement reference time of the one of the plurality of time related areas, which has the empty space, has already passed.

8. The control device according to claim 2, wherein
the moving unit moves the vehicle parked in the another one of the plurality of time related areas to the empty space of the one of the plurality of time related areas, and
the another one of the plurality of time related areas being correlated with the scheduled exit time immediately later than the scheduled exit time of the one of the plurality of time related areas.

9. The control device according to claim 1, wherein,
when the time acquisition unit fails to acquire the scheduled exit time of the vehicle to be parked in the automated valet parking lot, the parking position setting unit sets the parking position of the vehicle within the automated valet parking lot to satisfy a distance from the parking position of the vehicle to the exit room being longer than a distance from each of the plurality of time related areas to the exit room.

10. A control method used in an automated valet parking lot, the automated valet parking lot including an entrance room, an exit room, and a parking space, the control method being executed by a computer, and comprising:
setting a plurality of time related areas in the parking space, the plurality of time related areas being correlated to respective scheduled exit times different from one another;
acquiring a scheduled exit time of a vehicle to be parked in the automated valet parking lot;
selecting, from the plurality of time related areas, a target parking area of the vehicle corresponding to the acquired scheduled exit time;
setting a parking position of the vehicle in the selected target parking area; and
setting each of the plurality of time related areas to have a shorter travel distance to the exit room than other time related areas when the correlated scheduled exit time is earlier than those of other time related areas.

11. A control program stored in a computer-readable non-transitory storage medium, the control program product comprising instructions to be executed by at least one processor for performing a parking control within an automated valet parking lot, the automated valet parking lot including an entrance room, an exit room, and a parking space, the instructions comprising:
setting a plurality of time related areas in the parking space, the plurality of time related areas being correlated to respective scheduled exit times different from one another;
acquiring a scheduled exit time of a vehicle to be parked in the automated valet parking lot;
selecting, from the plurality of time related areas, a target parking area of the vehicle corresponding to the acquired scheduled exit time;
setting a parking position of the vehicle in the selected target parking area; and
setting each of the plurality of time related areas to have a shorter travel distance to the exit room than other time related areas when the correlated scheduled exit time is earlier than those of other time related areas.
